(19) United States
(12) Patent Application Publication
(10) Pub. No.: US 2007/0222707 A1
(43) Pub. Date: Sep. 27, 2007

(54) Method and Apparatus for Generating a Look-Up Table in the Video Picture Field

(75) Inventors: Cedric Thebault, Villingen-Schwenningen (DE); Carlos Correa, Villingen-Schwenningen (DE); Sebastien Weitbruch, Kappel (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING, Boulogne-Billancourt (FR)

(21) Appl. No.: 10/583,427

(22) PCT Filed: Dec. 14, 2004
(86) PCT No.: PCT/EP04/53448

§ 371 Date: May 10, 2007

(30) Foreign Application Priority Data
Dec. 18, 2003 (EP) 03293217.0
Apr. 7, 2004 (EP) 04008494.9

(51) Int. Cl. G09G 3/28

(52) U.S. Cl. 345/60

(57) ABSTRACT

The present invention is particularly useful in the field of plasma display panels (PDPs) or other display devices wherein each video level is represented by a combination of bits according to a specific coding. In this case, when the algorithms used to improve picture quality are based on data stored in memories such as look-up tables (LUTs), the size of such tables may be quite huge. To improve picture quality in PDPs, an algorithm using metacode LUTs has been developed, using data stored in look-up tables. The invention proposes a way to reduce the amount of look-up tables needed for implementing metacodes. According to the invention, only some look-up tables of low size are stored and the other ones are achieved by extrapolation.

The present invention relates to a method for generating a look-up table in the video picture field. It also relates to a circuit for implementing said method.

The present invention is particularly useful in the field of plasma display panels (PDPs) or other display devices wherein each video level is represented by a combination of bits according to a specific coding. In this case, when the algorithms used to improve picture quality are based on data stored in memories such as look-up tables (LUTs), the size of such tables may be quite huge.

### BACKGROUND OF THE INVENTION

To understand the problem, the present invention will be described in relation with PDP but may be applicable to other types of display or other apparatus processing video data and requiring memories with huge size. T-o improve picture quality in PDPs, a lot of algorithms have been developed, using data stored in look-up tables. For example, in EP patent application 1 353 314, is described a method for improving grey scale fidelity portrayal based on a modification of the coding approach for each average power level (APL) that occurs at each frame. It is based on a Metacode concept wherein the subfield code based on subfield weights is replaced by a metacode based on subfield actual luminance. More specifically, for a given peak white level, the sustain pulses are distributed among the sub-fields, the number of pulses of a sub-field corresponding to its weighting. Then, the sub-field codes are mapped to luminance codes, which are re-ordered in a definite order. Moreover, the video levels are mapped to the available luminance codes and processed to achieve intermediate levels of luminance. Then, the luminance codes are mapped to the output sub-field codes. In this case, look-up tables are used at least for mapping the video levels to the luminance codes and for mapping the luminance codes to the output sub-field codes. These look-up tables, which contain, for example, luminance codes to be loaded for each new APL value, are stored in an external memory. These tables, called metacode look-up tables, are quite huge.

FIG. 1 is a standard implementation circuit of a metacode coding unit as described in EP patent application 1 353 314. This unit comprises a first memory 100 comprising 1024×12 bits for handling 10 bits of input video resolution. A first metacode look up table is stored in this memory and is used for mapping the video levels to available luminance codes. It can include or not a degamma function. A new metacode look up table is loaded in the memory 100 each time the APL value changes. At the output of the memory 100, 12 bits video signal is obtained. The available 12-bits correspond to 8-bits integer resolution and 4-bits fractional resolution. Then, the 12-bits of video signal YA [11-0] are forwarded to a dithering circuit 110. In this circuit 110, the 4-bits of fractional resolution are added with the 4-bits of dithering and then truncated.

The video signal YB[7,0] from the circuit 110 is then forwarded to a second memory 120 comprising 256×16 bits. A second look-up table is stored in the memory 120 and is used to implement the transcoding step that is the step of mapping luminance codes to the output subfield codes.

As mentioned previously, the memory 100 needs to be updated with a new metacode look-up table each time the APL value changes. A look-up table is provided for each APL value. These look-up tables are stored in an external memory 130, e.g. a FLASH memory, EEPROM, . . . A metacode look-up table defines, for each video level and for a given APL value, a 12 bit code representative of the luminance code to be generated for achieving the video level. In case of a 10 bit APL value, an external memory with a size of 1024×1024×12=12 Mbit is needed.

Moreover, if different metacode look-up tables are needed for each color, it increases the total size of the memory 130 to 36 Mbit. Furthermore, since the metacode look-up tables are different for each display mode used in the Plasma Display Panel, e.g. 60 Hz, 50 Hz, 75 Hz . . . it further increases the needs in terms of external memory: 108 Mbit for 3 modes.

Therefore, one major problem of the implementation circuit of FIG. 1 is the large size of the external memory 130.

It is the purpose of the present invention to propose a way to reduce the amount of data needed for implementing said metacode method by using a low number of metacode look-up tables and by extrapolating the other ones.

In a general manner, the invention relates to a method for generating a look-up table for a given value of a parameter among N different values, whose output values can be approximated by a piecewise linear function of a variable (S(VAL)) depending on the given value.

The method of the invention can be used for generating a metacode look-up table for a given value of average power level.

It can also be used for generating other look-up tables in the video picture field.

### SUMMARY OF THE INVENTION

So, the invention proposes a method for generating a look-up table for a given value of a parameter among N different values, whose output values can be approximated by a piecewise linear function of a variable depending on the given value, characterized in that it comprises the following steps:
dividing the set of N values into P subsets of consecutive values, each piece of the piecewise linear function being in a different subset;
defining a look-up table for the two bound values of each subset i, called primary look-up table and secondary look-up table respectively,
defining, for each subset i, a delta look-up table corresponding to the difference between the secondary look-up table and the primary look-up table related to the subset i,
defining, for each one of said N values, an extrapolation coefficient in accordance with the value of a variable S for the given value and the values of the variable S for the two bound values of the subset i comprising the given value; and
computing a look-up table, for the given value in accordance with the related extrapolation coefficient, primary look-up table and delta look-up table.

In the embodiment described here, the generated look-up table is a Metacode look-up table, the parameter is an average power level and the variable is a number of sustain pulses corresponding to the given value of the parameter.

The bound level related to the primary look-up table of a subset of average power level values is the highest average power level value of the subset and the bound level related to the secondary look-up table of a subset of average power level values is the lowest average power level value of the subset.

Preferably, the ratio between the value of the variable for one bound value in the subset i and the value of the variable S for the same bound value in the subset i+1 equals to a fixed parameter o. The parameter ox is defined as followed

$$α = \sqrt[N]{\frac{{S}_{MAX}}{{S}_{MIN}}}$$

where S_{MAX} is the value of the variable S for a peak white image and S_{MIN} for a full white image. The extrapolation coefficient equals to

$$C ( VAL ) = \frac{S ( VAL ) - S ( {PMTC}_{i} )}{S ( {SMTC}_{i} ) - S ( {PMTC}_{i} )}$$

where S(PMTCᵢ) is the value of the variable S for the highest bound value of the subset i; S(SMTCᵢ) is the value of the variable S for the lowest bound value of the subset i; and S(VAL) is the value of the variable for the given value.

The computed look-up table equals to the sum of the output of the primary look-up table (PMTCᵢ) for the given value (VAL) and the output of the delta look-up table (PMTCᵢ) for the given value (VAL) weighted by the extrapolation coefficient for the given value (VAL).

The invention concerns also a device for generating a look-up table for a given value of a parameter among N different values, whose output values can be approximated by a piecewise linear function of a variable depending on the given value, the set of N values being divided into P subsets of consecutive values, each piece of the piecewise linear function being in a different subset, characterized in that it comprises:
a first memory for storing, for each subset i, a primary look-up table associated to a bound value of the subset i,
a second memory for storing, for each subset i, a delta look-up table corresponding to the difference between a secondary look-up table and the primary look-up table related to the subset i, the secondary look-up table being associated to the other bound value of the subset i,
a third memory for storing, for each of said N values, an index indicating which primary look-up table in the first memory and which delta look-up table in the second memory have to be used for extrapolation,
a fourth memory for storing an extrapolation coefficient; for each one of said N values, the extrapolation coefficient associated to a given value being defined in accordance with the value of a variable S for said given value and the values of the variable S for the two bound values of the subset i comprising said given value; and
a computing block for generating a look-up table, for the given value in accordance with the related extrapolation coefficient, primary look-up table and delta look-up table.

The above-mentioned method can be implemented in this device.

### DRAWINGS

Exemplary embodiments of the invention are illustrated in the drawings and are explained in more detail in the following description.

In the figure:

FIG. 1 is a schematic showing an implementation of a prior art method; and

FIG. 2 is a schematic showing a possible implementation of the method according to the invention.

### DESCRIPTION OF PREFERRED EMBODIMENTS

The present invention will be described with reference to the generation of metacode look-up tables for different Average Power Level or APL values.

The goal of the invention is to reduce the number of look-up tables needed. Only some look-up tables will be predefined for some APL values and, for the other APL values, new look-up tables will be extrapolated from these predefined look-up tables.

In the following specification, a metacode LUT, defined for a given APL value, defines for each input video level an output level expressing a luminance code to be used.

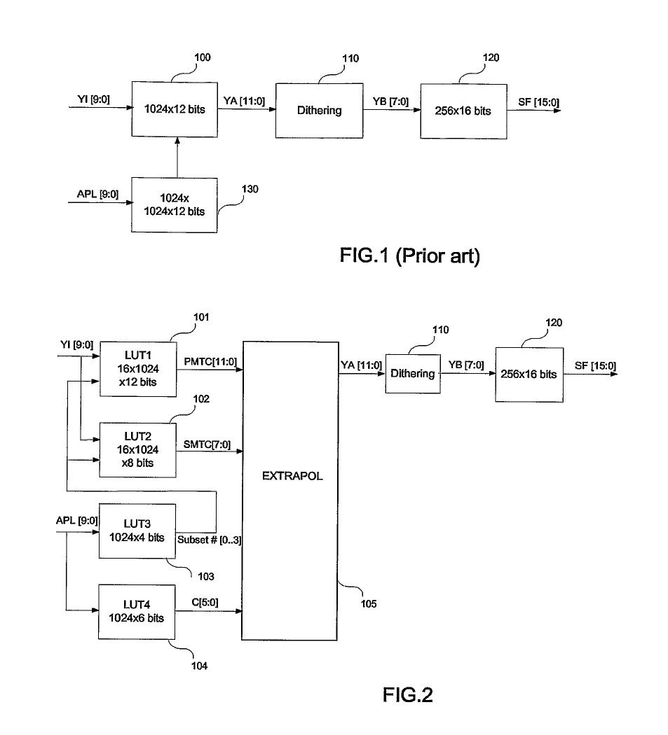

According to the invention and as illustrated by FIG. 2, four look-up tables with a total size inferior to the size of the memory 130 of FIG. 1 and an evaluation block are used to implement the metacode look-up tables for all APL values:
a first look-up table LUT1 which comprises itself 16 metacode LUTs, called primary metacode LUTs; each primary metacode LUT comprises metacodes related to a specific APL value, called primary APL value; the primary APL values will be described below in the specification;
a second look-up table LUT2 which comprises 16 delta LUTs corresponding to the difference between secondary metacode LUTs and said primary metacode LUTs; each secondary metacode LUT comprises metacodes related to a specific APL value, called secondary APL value; the secondary APL values will be described below in the specification;
a third look-up table LUT3 which comprises, for each APL value, an index indicating which primary metacode LUT in LUT1 and which delta LUT in LUT2 have to be used for the extrapolation,
a fourth look-up table LUT4 which comprises, for each APL value, the coefficient to be used for the extrapolation, and
an extrapolation block EXTRAPOL for calculating a LUT.

As mentioned above, each subset of APL values comprises a primary APL value and a secondary APL value. The set of APL values comprises for example 1024 values from 0 to 1023 and is for example divided into 16 subsets of consecutive APL values. The primary APL value is the highest APL value (corresponding to the smallest number of sustain pulses) of the subset and the secondary APL value is the lowest APL value (corresponding to the highest number of sustain pulses) of the subset. A primary metacode LUT is defined for each primary APL value. These primary metacode LUTs are stored in the LUT1. A secondary metacode LUT is defined for,each secondary APL value but these secondary metacode LUTs are not stored in the LUT1 or LUT2. They are only used for calculating the delta LUTs stored in LUT2.

The Look-up table LUT3 delivers, for each APL value, a pointer on the primary Metacode LUT which has to be used for generating the Metacode LUT of this APL value. The LUT 3 has a 10-bit input and a 4-bit output for selecting one of the 16 primary metacode LUTs.

The notations used in the specification are the following ones:
PMTCᵢ represents the primary metacode LUT related to the subset i of APL values,
S(PMTCᵢ) represents the number of sustain pulses for the APL value (primary APL value) corresponding to the primary metacode LUT PMTCᵢ;
PMTCᵢ(V) represents the output of the primary metacode LUT PMTCᵢ for the video level V;
SMTC i represents the secondary metacode LUT related to the subset i of APL values,
S(SMTCᵢ) represents the number of sustain pulses for the APL value corresponding to the secondary metacode LUT SMTCᵢ;
SMTCᵢ(V) represents the output of the secondary metacode LUT SMTCᵢ for the video level V; and
S(X) represents of the number of sustain pulses for the APL value X.

Some jumps can appear when switching from one primary metacode LUT to another one. For example, the smallest sub-field code value (1 sustain pulse for example) has a different (different in comparison with which value ?) relative value (which is equal to 1/total amount of sustain pulses) since the total amount of sustain pulses changes from one primary Metacode level to another one (from one APL value to another). The ratio of these two different values (which is equal to the ratio of the two different total amounts of sustain pulses of the two primary metacode LUTs) could create a jump.

In order to have nearly the same visibility of possible jumps when switching from one primary Metacode to another one, these ratios should be equal as follows:

$$\frac{S ( {PMTC}_{0} )}{S ( {PMTC}_{1} )} = \frac{S ( {PMTC}_{1} )}{S ( {PMTC}_{2} )} = … = \frac{S ( {PMTC}_{i} )}{S ( {PMTC}_{i + 1} )} = … = \frac{S ( {PMTC}_{14} )}{S ( {PMTC}_{15} )} = α$$

This means that the division is made in a logarithmic way. The previous formula means that the 2^{nd} the 3^{rd}, . . . and the 15^{th} subsets of APL values have the same ratio between the number of sustain pulses of their smallest APL value and their highest value. If this ratio a: is also imposed to the first subset, we have

$$α = \frac{{S}_{MAX}}{S ( {PMTC}_{0} )} = \frac{S ( {PMTC}_{0} )}{S ( {PMTC}_{1} )} = … = \frac{S ( {PMTC}_{i} )}{S ( {PMTC}_{i + 1} )} = … = \frac{S ( {PMTC}_{14} )}{S ( {PMTC}_{15} )}$$

where S_{MAX} is the number of sustain pulses for a peak white (low APL value)
When multiplying all terms together, we find that:

$${α}^{16} = \frac{{S}_{MAX}}{S ( {PMTC}_{15} )} = \frac{{S}_{MAX}}{{S}_{MIN}}$$

where S_{MIN} is the number of sustain pulses for a full white image.
So

$$α = \sqrt[16]{\frac{{S}_{MAX}}{{S}_{MIN}}} and S ( {PMTC}_{i} ) = {S}_{MIN} \times {α}^{15 - i}$$

This division in a logarithmic way is only a suggestion in order to have the same visibility of possible jumps when switching from one primary metacode LUT to another one; but it is possible to use a different division of the APL set. For example, it is possible to use a different division in order to have more subsets for the low values of APL, and less for the high values of APL.

In an example given in the annex below, the set of APL values is divided in 16 subsets. The primary APL values (lowest APL value of each subset) are marked in bold characters and the secondary APL values (highest APL values: of each subset) are marked in black areas.

This example is given for the following inputs:
Peak white image: 1100 sustain pulses
Full white image: 200 sustain pulses.

The parameter a is equal to:

$$α = \sqrt[16]{\frac{{S}_{MAX}}{{S}_{MIN}}} = \sqrt[16]{\frac{1100}{200}} \approx 1.1135 .$$

The 16 primary APL values, used for the primary Metacode LUTs, are determined as indicated in the annex table. The maximal number of sustain pulses of the primary metacode LUT PMTCᵢ is 200×αⁱ sustain pulses, with i=0 . . . 15.

The APL values are distributed as follows:
APL values from 0 to 135+Subset 15
APL values from 136 to 230+Subset 14
APL values from 231 to 318+Subset 13
APL values from 319 to 398+Subset 12
APL values from 399 to 473+Subset 11
APL values from 474 to 540+Subset 10
APL values from 541 to 604+Subset 9
APL values from 605 to 663+Subset 8
APL values from 664 to 716+Subset 7
APL values from 717 to 766+Subset 6
APL values from 767 to 812+Subset 5
APL values from 813 to 856+Subset 4
APL values from 857 to 898+Subset 3
APL values from 899 to 938+Subset 2
APL values from 939 to 978+Subset 1
APL values from 979 to 1023+Subset 0

As an example, for the subset 15, the primary APL value is 135 and the secondary APL value is 0. The maximal number of sustain pulses for the primary metacode LUT is 988 and for the secondary metacode LUT is 1100. The metacode LUTs related to APL values comprised between 1 and 134 of subset 15 are computed by extrapolation. It is an extrapolation in the sense that it is not an interpolation between two metacode LUTs related to different subsets. These metacode LUTs related to APL values 1 . . . 134 can be achieved by an interpolation between the primary metacode LUT related to the APL value 135 and the secondary Metacode LUT related to the APL value 0. The secondary metacode LUT is only used for the extrapolation. In a preferred embodiment, the extrapolation for the APL values of a subset i is made between the primary metacode LUT PMTCᵢ an d a delta LUT corresponding to the difference between primary metacode LUT PMTCᵢ and the secondary metacode LUT SMTCᵢ. This difference LUT, noted LUT2ᵢ, is stored in the look up table LUT2. The values in the delta LUTs contained in this LUT2 can be positive or negative, but a 8 bit resolution is enough.

The value stored in the delta LUT related to the subset i in the LUT2 and precalculated for a video level V is:

$$LUT {2}_{i} ( V ) = \frac{64 \times ( {SMTC}_{i} ( V ) - {PMTC}_{i} ( V ) )}{63}$$

(Why the coefficient 64/63 ?)

Preferably, for evaluating the look-up table LUT2, more resolution should be used for PMTCᵢ(V) and SMTCᵢ(V) than available for the LUT1.

The extrapolation coefficient for an APL value belonging to the subset i, referenced C(APL), used for the extrapolation is the ratio of the difference between the number of sustain pulses of the current APL, NbSustain(APL), and S(PMTCᵢ) to the difference between S(SMTCᵢ) and S(PMTCᵢ). 6 bit resolution is enough for this coefficient.

$$C ( APL ) = 63 \times \frac{S ( APL ) - S ( {PMTC}_{i} )}{S ( {SMTC}_{i} ) - S ( {PMTC}_{i} )}$$

(Why the coefficient 63 ?)

The final extrapolation is:
output(V)=LUT1ᵢ(V)+(LUT2ᵢ(V)×C(APL))/64
(Why the coefficient 64?)

The primary Metacode LUTs are independent of the principle of the invention. Only, the other metacode LUTs are achieved from these primary metacode LUTs.

A possible implementation of the method of the invention is illustrated by FIG. 2 as indicated below. The look-up tables LUT1, LUT2, LUT3 and LUT4 are stored in four memories 101, 102, 103 and 104. They can be included in an external memory (EPROM or FLASH) that can be read bit sequentially by a controller. The extrapolation is calculated by an extrapolation block 105. This block is connected to the dithering block 110 of FIG. 1. In normal operation, at the end of every frame, new LUT1ᵢ and LUT2ᵢ data have to be downloaded by the controller depending on the APL value that has been computed during the active part of the video signal based on the video data.

This method needs only (16×1024×(12+8)+1024×(6+4))×3×3=2.9 Mbit for 3 modes instead of 108 Mbit with the method implemented in FIG. 1.

ANNEX

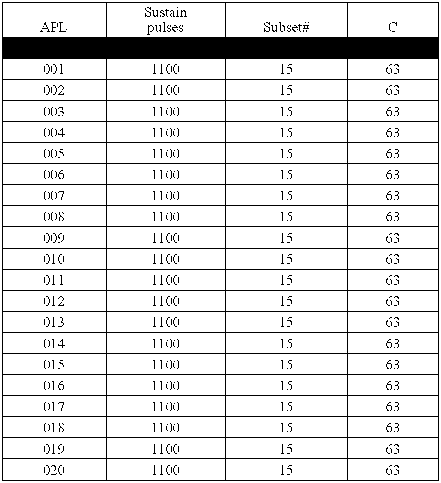

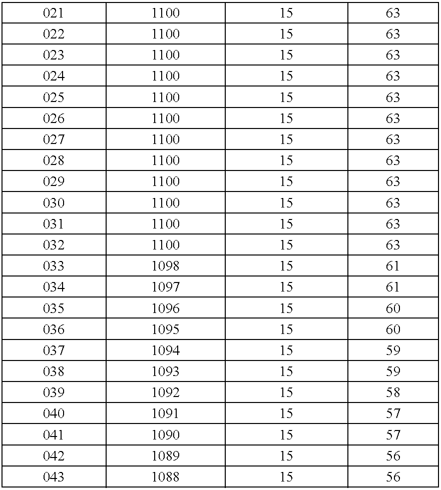

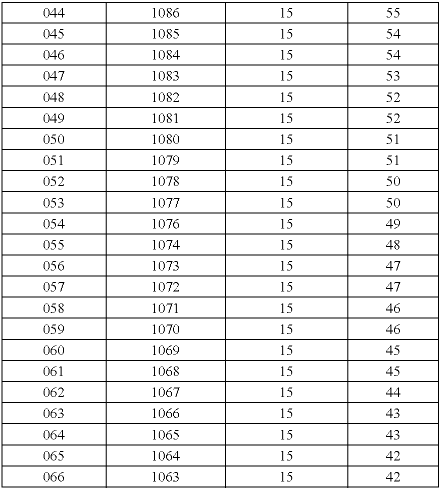

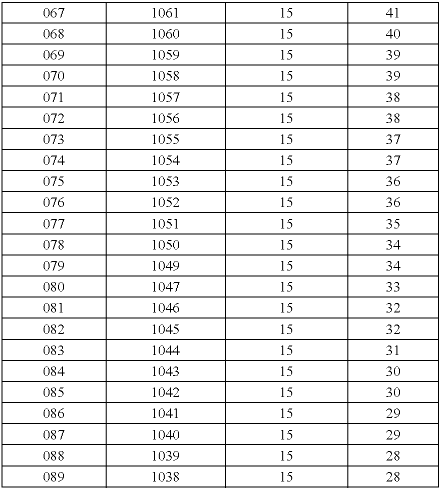

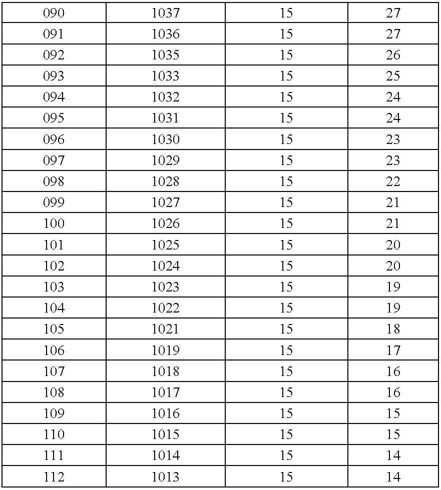

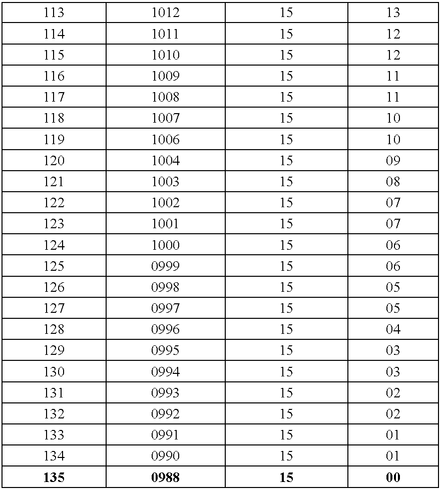

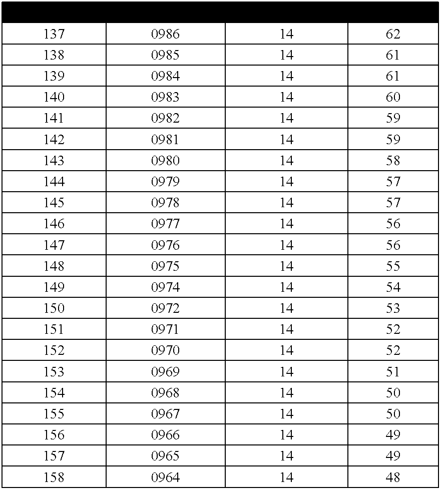

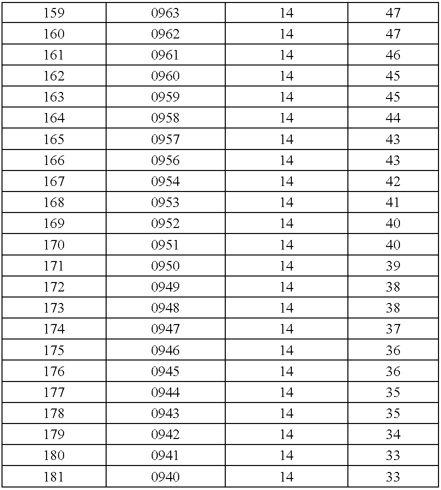

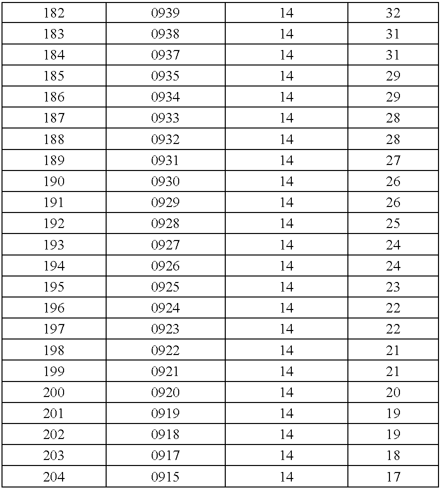

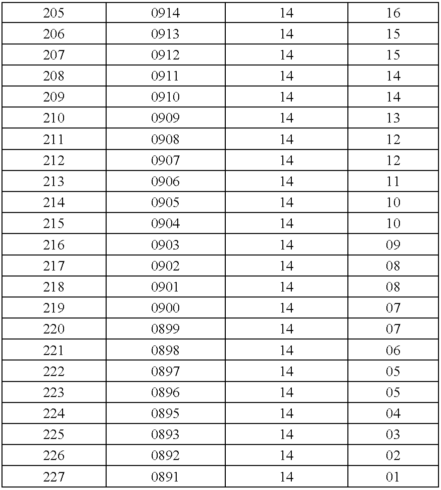

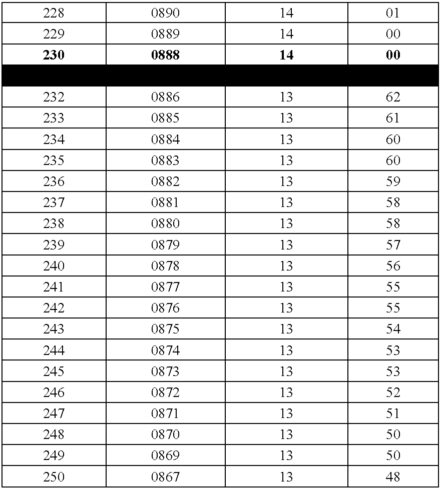

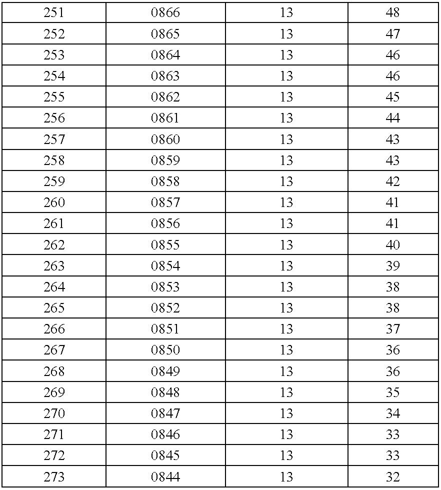

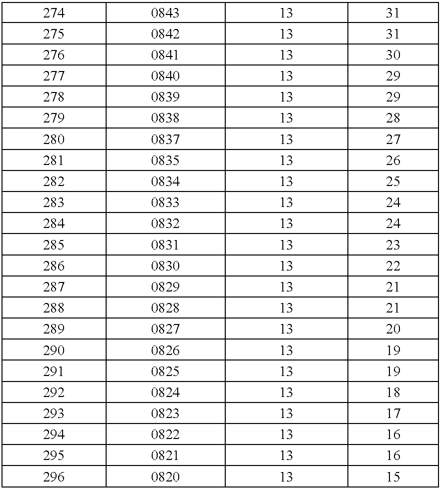

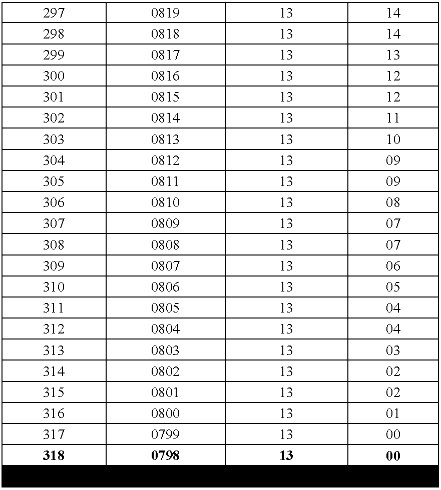

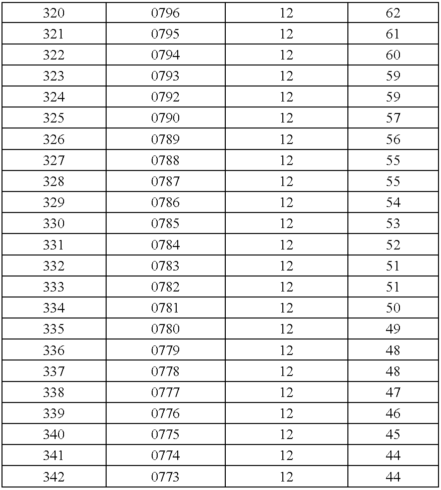

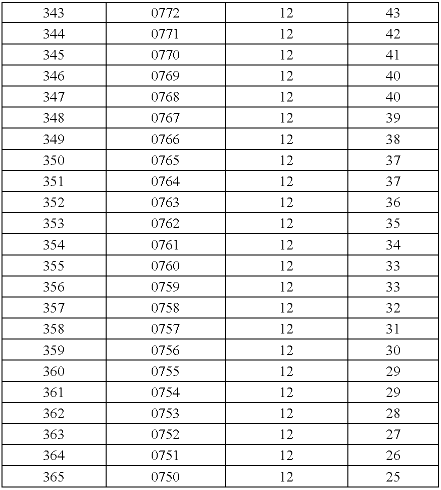

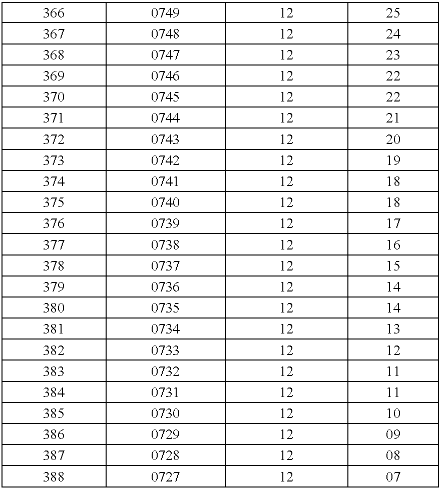

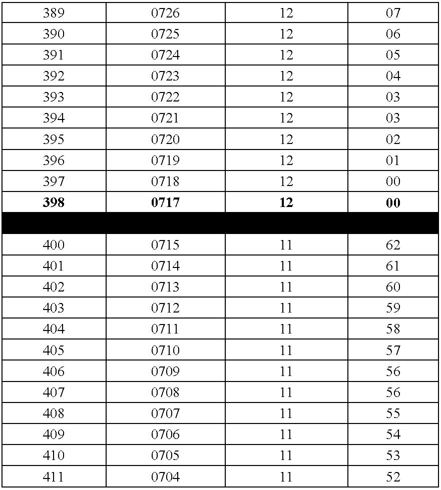

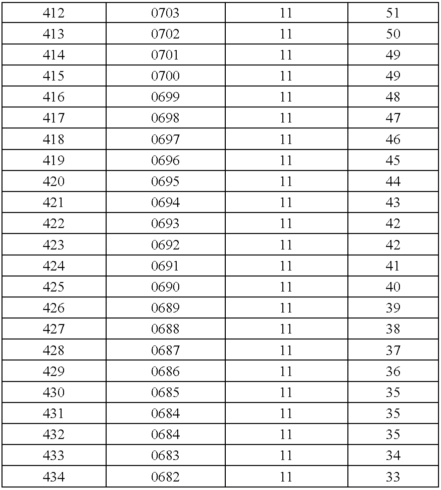

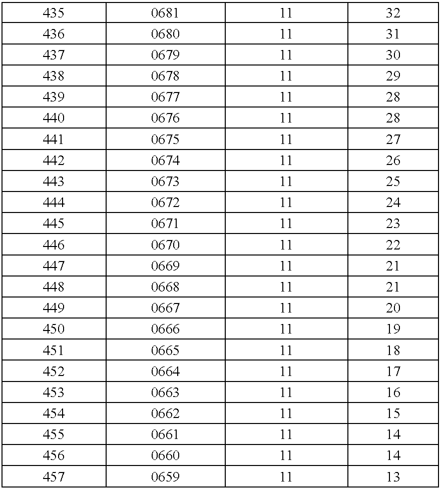

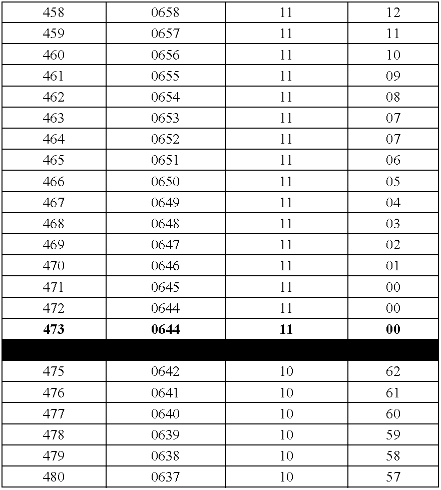

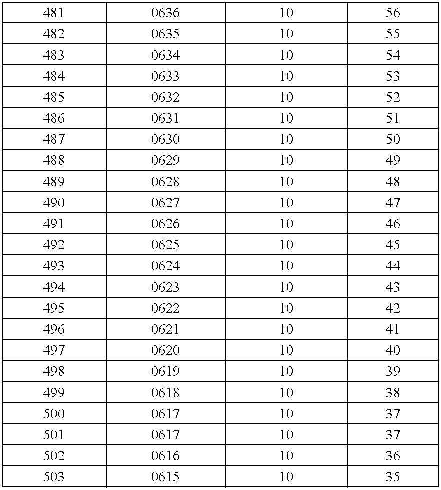

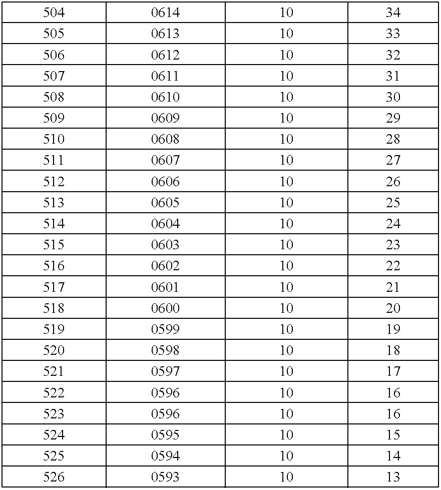

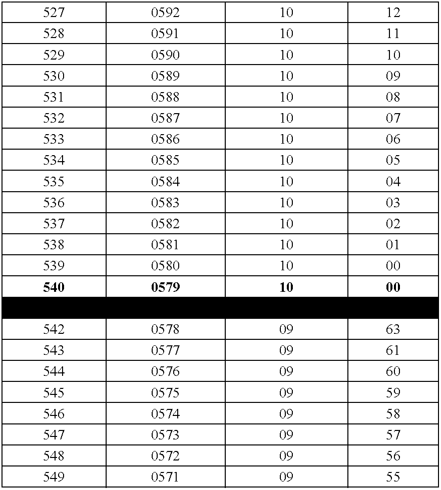

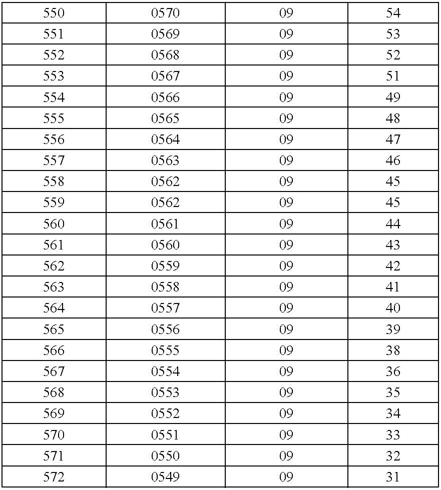

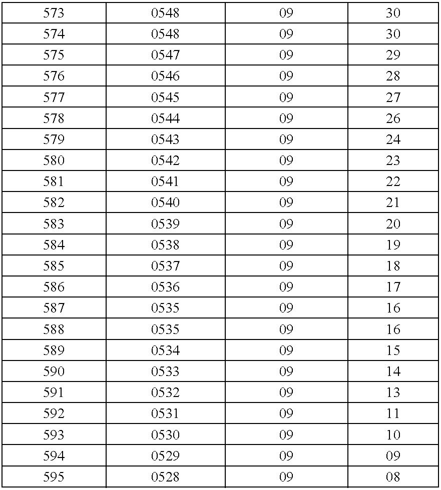

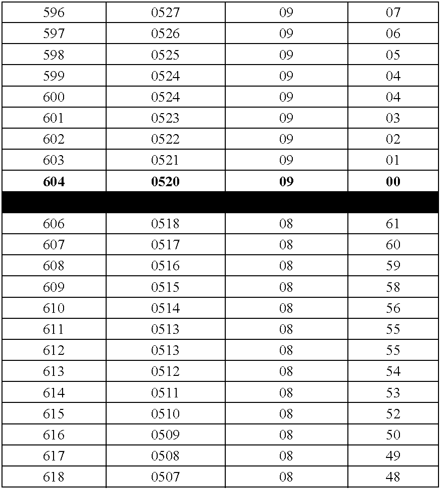

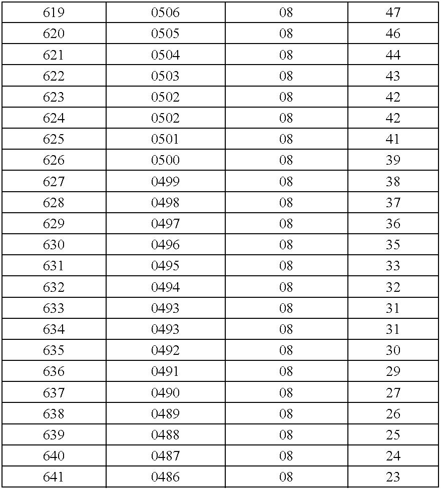

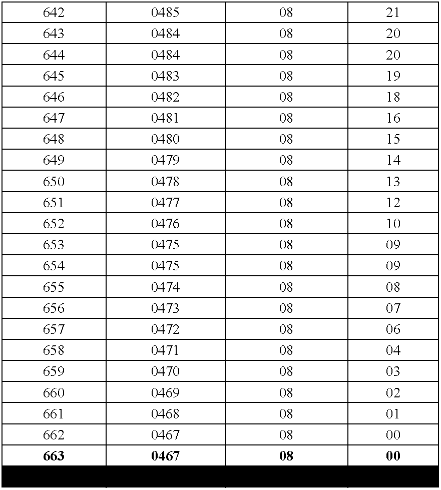

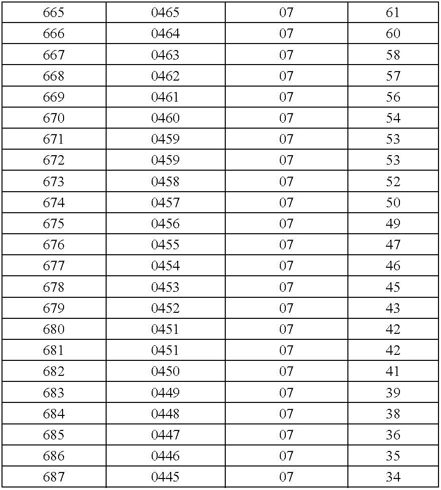

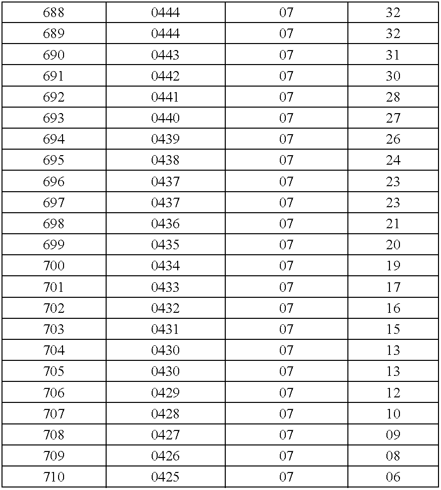

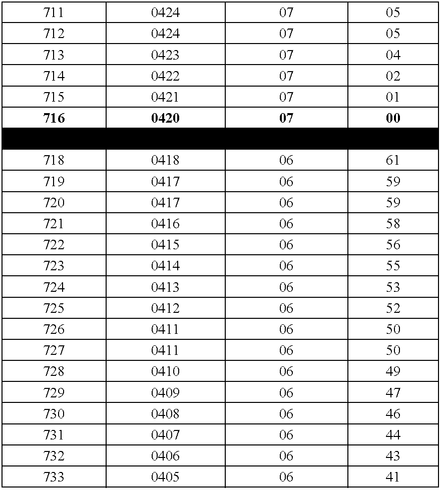

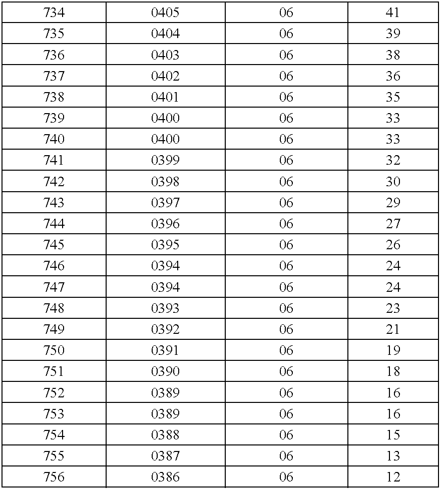

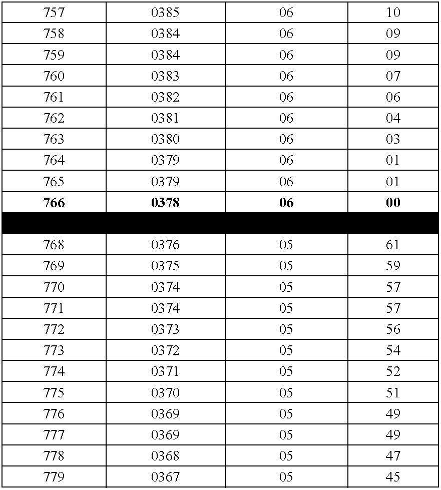

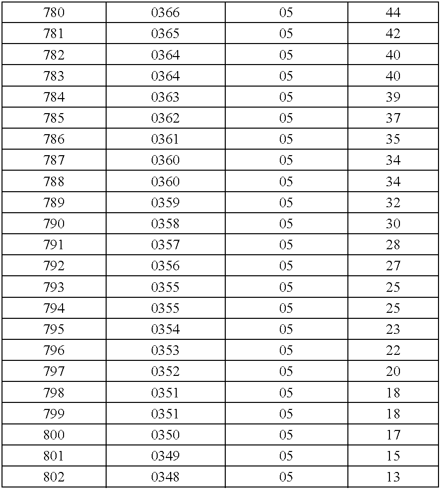

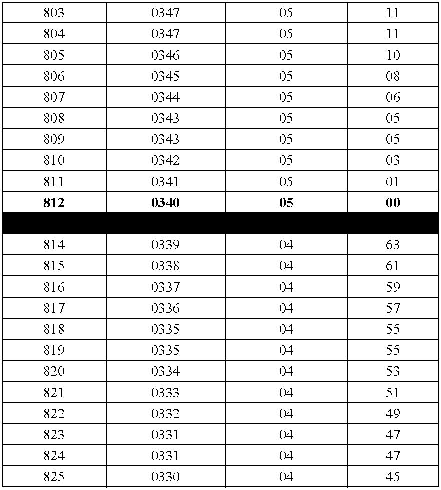

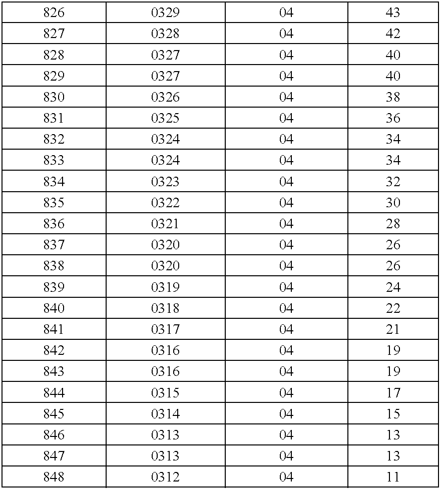

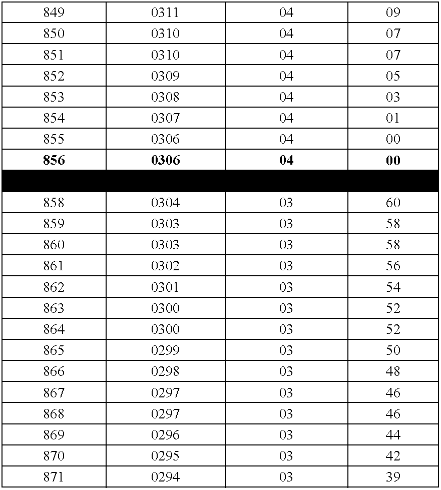

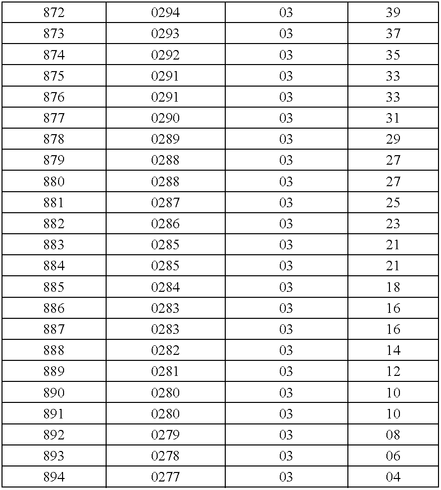

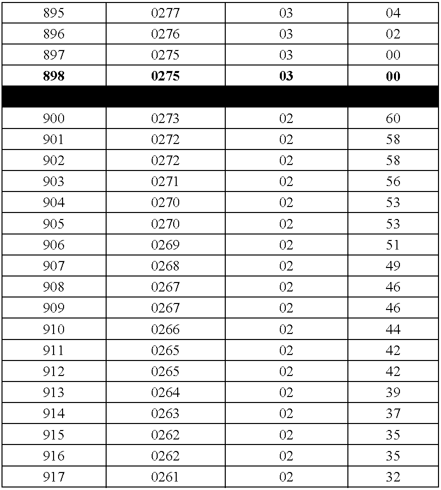

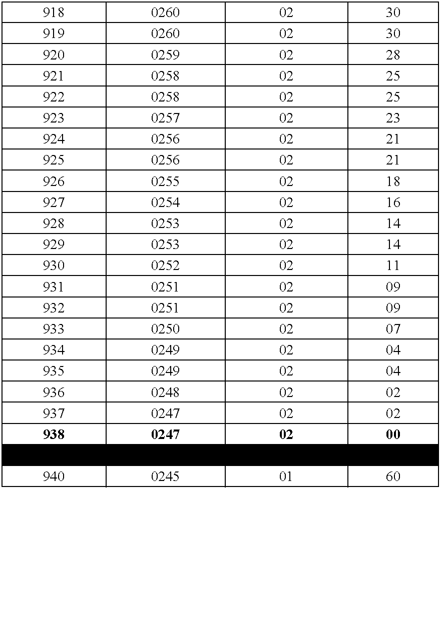

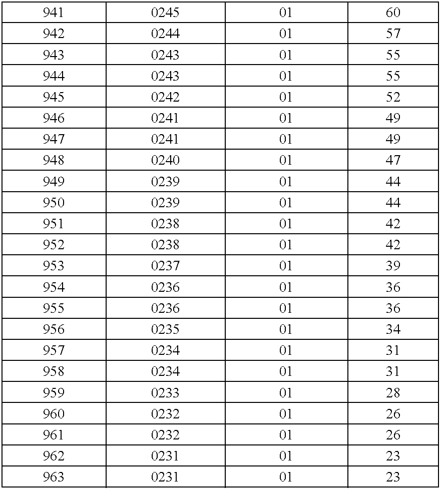

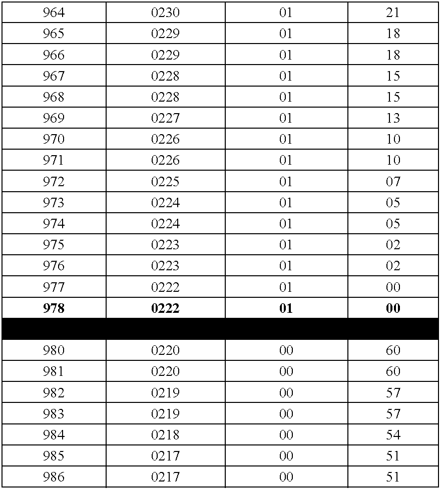

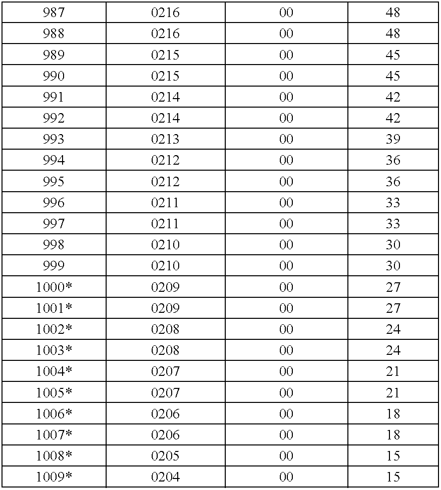

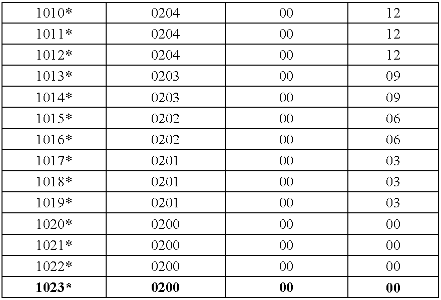

1. Method for generating a look-up table for a given value (VAL) of a parameter (APL) among N different values, whose output values can be approximated by a piecewise linear function of a variable (S(VAL)) depending on the given value, characterized in that it comprises the following steps:
dividing the set of N values into P subsets of consecutive values, each piece of the piecewise linear function being in a different subset;
defining a look-up table for the two bound values of each subset i, called primary look-up table (PMTCᵢ) and secondary look-up table (SMTCᵢ) respectively,
defining, for each subset i, a delta look-up table corresponding to the difference between the secondary look-up table (SMTCᵢ) and the primary look-up table (PMTCᵢ) related to the subset i,
defining, for each one of said N values, an extrapolation coefficient (C(VAL)) in accordance with the value (S(VAL)) of a variable S for the given value (VAL) and the values (S(PMTCᵢ),S(SMTCᵢ)) of the variable S for the two bound values of the subset i comprising the given value; and
computing a look-up table, for the given value (VAL) in accordance with the related extrapolation coefficient (C(VAL)), primary look-up table (PMTCᵢ) and delta look-up table.

2. Method according to claim 1, characterized in that the look-up table is a Metacode look-up table, the parameter is an average power level and the variable (S(VAL)) is a number of sustain pulses corresponding to the given value (VAL) of the parameter.

3. Method according to claim 2, characterized in that the bound level related to the primary look-up table (PMTCᵢ) of a subset of average power level values is the highest average power level value of the subset and the bound level related to the secondary look-up table (SMTCᵢ) of a subset of average power level value s is the lowest average power level value of the subset.

4. Method according to one of the claims 1 to 3, characterized in that the ratio between the value (S(PMTCᵢ)) of the variable for one bound value in the subset i and the value (S(PMTCᵢ₊₁)) of the variable for the same bound value in the subset i+1 equals to a fixed parameter α.

5. Method according to the claim 4, characterized in that the parameter ox is defined as followed:
$$α = \sqrt[N]{\frac{{S}_{MAX}}{{S}_{MIN}}}$$
where S_{MAX} is the value of the variable (S) for a peak white image and S_{MIN} for a full white image.

6. Method according to one of the claims 1 to 5, characterized in that the extrapolation coefficient (C(VAL)) equals to:
$$C ( VAL ) = \frac{S ( VAL ) - S ( {PMTC}_{i} )}{S ( {SMTC}_{i} ) - S ( {PMTC}_{i} )}$$
where—S(PMTCᵢ) is the value of the variable for the highest bound value of the subset i;
S(SMTCᵢ) is the value of the variable for the lowest bound value of the subset i; and
S(VAL) is the value of the variable for the given value.

7. Method according to one of the claims 1 to 6, characterized in that the computed look-up table equals to the sum of the output of the primary look-up table (PMTCᵢ) for the given value (VAL) and the output of the delta look-up table (PMTCᵢ) for the given value (VAL) weighted by the extrapolation coefficient for the given value (VAL).

8. Device for generating a look-up table for a given value (VAL) of a parameter (APL) among N different values, whose output values can be approximated by a piecewise linear function of a variable (S(VAL)) depending on the given value, the set of N values being divided into P subsets of consecutive values, each piece of the piecewise linear function being in a different subset, characterized in that it comprises:
a first memory (101) for storing, for each subset i, a primary look-up table (PMTCᵢ) associated to a bound value of the subset i,
a second memory (102) for storing, for each subset i, a delta look-up table corresponding to the difference between a secondary look-up table (SMTCᵢ) and the primary look-up table (PMTCᵢ) related to the subset i, the secondary look-up table (SMTCᵢ) being associated to the other bound value of the subset i,
a third memory (103) for storing, for each of said N values, an index indicating which primary look-up table in the first memory (101) and which delta look-up table in the second memory (102) have to be used for extrapolation,
a fourth memory (104) for storing an extrapolation coefficient (C) for each one of said N values, the extrapolation coefficient (C(VAL)) associated to a given value being defined in accordance with the value (S(VAL)) of a variable S for said given value (VAL) and the values (S(PMTCᵢ),S(SMTCᵢ)) of the variable S for the two bound values of the subset i comprising said given value; and
a computing block (105) for generating a look-up table, for the given value (VAL) in accordance with the related extrapolation coefficient (C(VAL)), primary look-up table (PMTCᵢ) and delta look-up table.

9. Device according to claim 7, characterized in that the parameter is an average power level and the variable (S(VAL)) is a number of sustain pulses corresponding to the given value (VAL) of the parameter
and that it generates a Metacode look-up table for each average power level value.

10. Device according to claim 9, characterized in that the bound level related to the primary look-up table (PMTCᵢ) of a subset of average power level values is the highest average power level value of the subset and the bound level related to the secondary look-up table (SMTCᵢ) of a subset of average power level values is the lowest average power level value of the subset.

11. Method according to one of the claims 8 to 10, characterized in that the ratio between the value (S(PMTCᵢ)) of the variable for one bound value in the subset i and the value (S(PMTCᵢ₊₁)) of the variable for the same bound value in the subset i+1 equals to a fixed parameter α.

12. Device according to the claim 11, characterized in that the parameter a is defined as followed:
$$α = \sqrt[N]{\frac{{S}_{MAX}}{{S}_{MIN}}}$$
where S_{MAX} is the value of the variable (S) for a peak white image and S_{MIN} for a full white image.

13. Method according to one of the claims 8 to 12, characterized in that the extrapolation coefficient (C(VAL)) equals to:
$$C ( VAL ) = \frac{S ( VAL ) - S ( {PMTC}_{i} )}{S ( {SMTC}_{i} ) - S ( {PMTC}_{i} )}$$
where—S(PMTCᵢ) is the value of the variable for the highest bound value of the subset i;
S(SMTCᵢ) is the value of the variable for the lowest bound value of the subset i; and
S(VAL) is the value of the variable for the given value.

14. Device according to one of the claims 8 to 13, characterized in that the computed look-up table equals to the sum of the output of the primary look-up table (PMTCᵢ) for the given value (VAL) and the output of the delta look-up table (PMTCᵢ) for the given value (VAL) weighted by the extrapolation coefficient for the given value (VAL).
